(19) United States
(12) Patent Application Publication
(10) Pub. No.: US 2016/0042855 A1
(43) Pub. Date: Feb. 11, 2016

(54) MAGNETICALLY BIASED CHOKE

(71) Applicant: STS PEZIAL-TRANSFORMATOREN STOCKACH GMBH & CO. KG, Stockach (DE)

(72) Inventors: Christof GULDEN, Bodman-Ludwigshafen (DE); Bruce CARSTEN, Corvallis, OR (US); Stefan Herzog, Radolfzell (DE); Alexander STADLER, Erlangen (DE)

(73) Assignee: STS Spezial-Tranformatoren-Stockach GMBH & Co. KG, Stockach (DE)

(21) Appl. No.: 14/771,945

(22) PCT Filed: May 2, 2014
(86) PCT No.: PCT/DE2014/100154

§ 371 Date: Sep. 1, 2015

(30) Foreign Application Priority Data
May 2, 2013 (DE) 10 2013 208 058.1

(51) Int. Cl. H01F 27/24; H01F 27/26

(52) U.S. Cl. CPC H01F 27/24; H01F 27/263

(57) ABSTRACT

A magnetically biased choke includes a magnetic circuit with at least one stack consisting of a plurality of magnetically soft segments), of which at least some are disposed at a spacing from each other, and of a coil which is wound about the stack, at least two permanent magnet segments being inserted into the stack and at least one magnetically soft segment being disposed between the at least two permanent magnet segments.

### CROSS REFERENCE TO RELATED APPLICATIONS

This application relates to and claims priority as a 371 national-phase from PCT/DE2014/100154 filed May 2, 2014, the entire contents of which are incorporated herein by reference, which claims priority from DE Ser. No. 10 2013 208 058.1 filed May 2, 2013.

### FIGURE SELECTED FOR PUBLICATION

FIG. 1

### BACKGROUND OF THE INVENTION

1. Field of the Invention

The present invention relates to a magnetically biased choke. More particularly, the present invention relates to a magnetically biased choke having a magnetic circuit with at least one stack consisting of a plurality of magnetically soft segments), of which at least some are disposed at a spacing from each other, and of a coil which is wound about the stack, at least two permanent magnet segments being inserted into the stack and at least one magnetically soft segment being disposed between the at least two permanent magnet segments.

2. Description of the Related Art

Inductances with a magnetic circuit made of magnetically soft core material and a coil wound about a part of the core material are known throughout the electrical engineering industry. The magnetic circuit frequently also has a gap that extends from a first free end on the front of the core material to a second free end on the front of the core material on the opposite side.

Magnetic circuits with multiple gaps with inserted insulators are also known, moreover. An example for this is the European patent EP 1 501 106 B1 of the applicant, the contents of which are incorporated herein by reference.

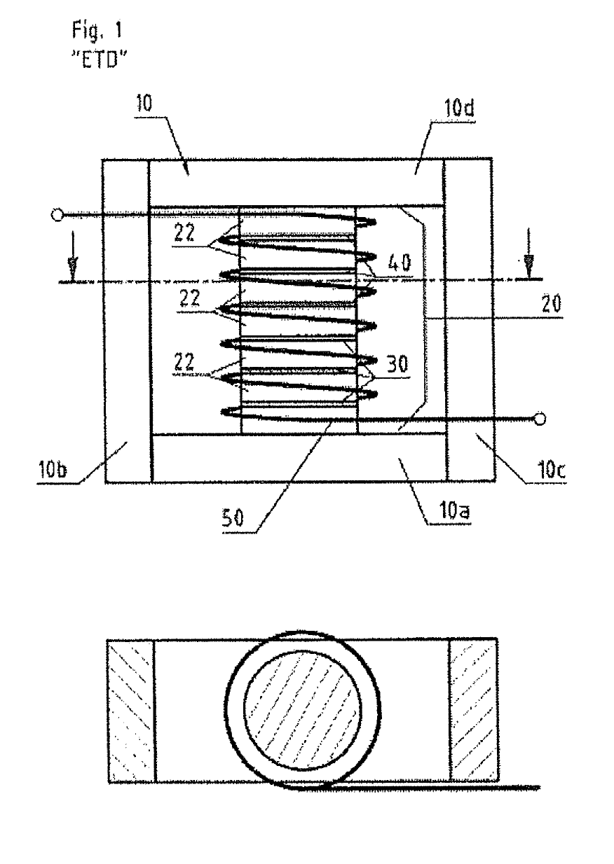

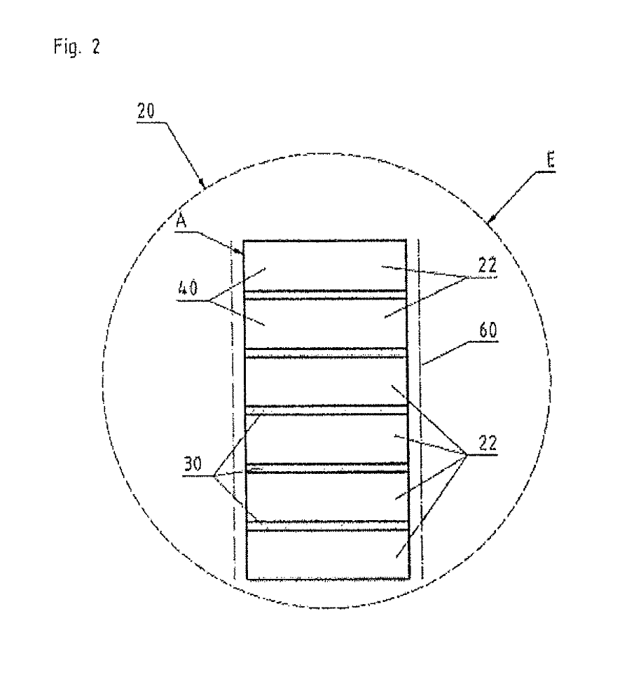

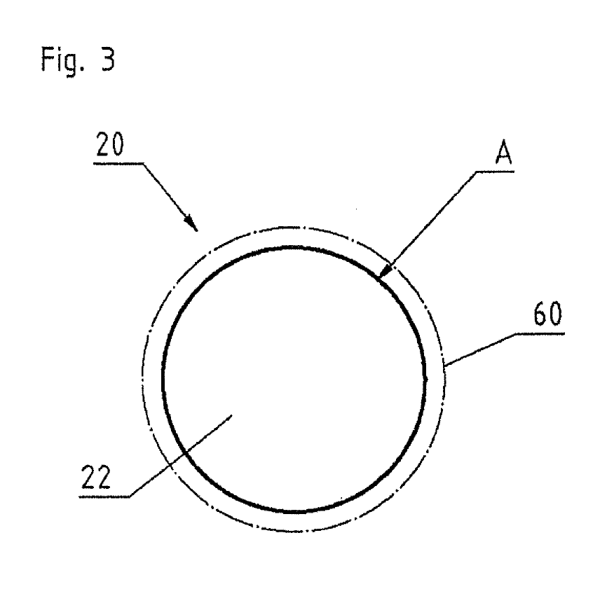

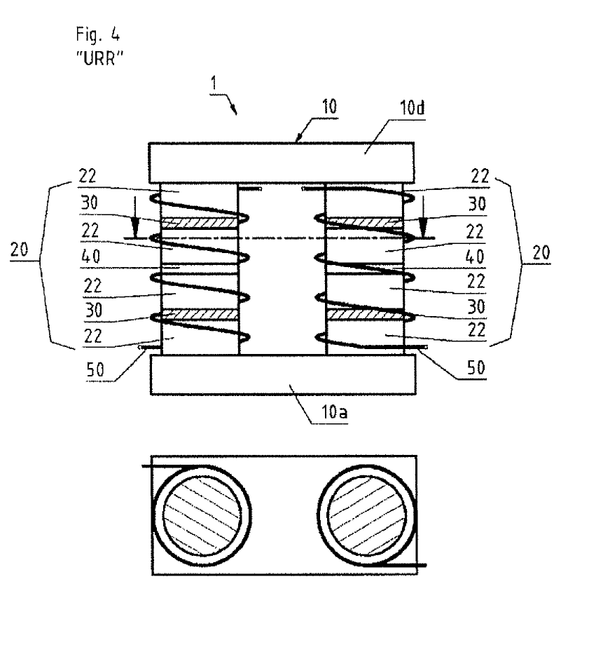

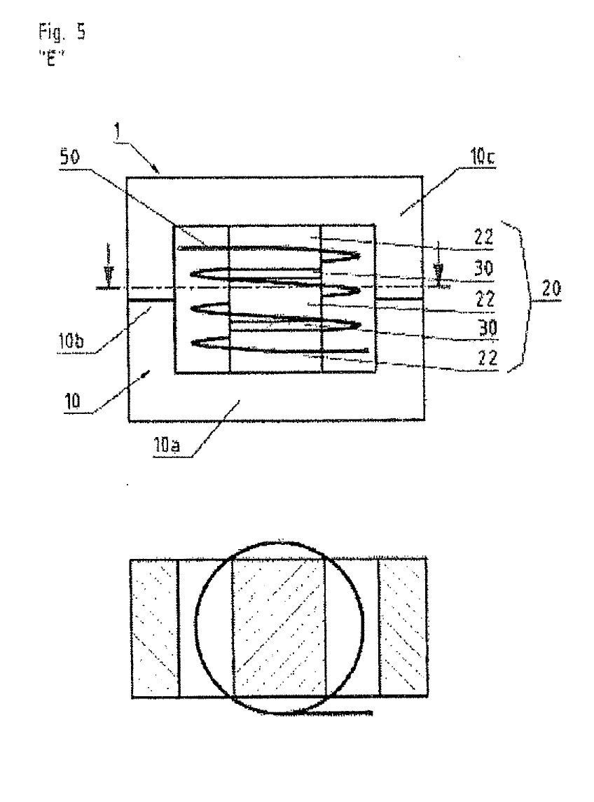

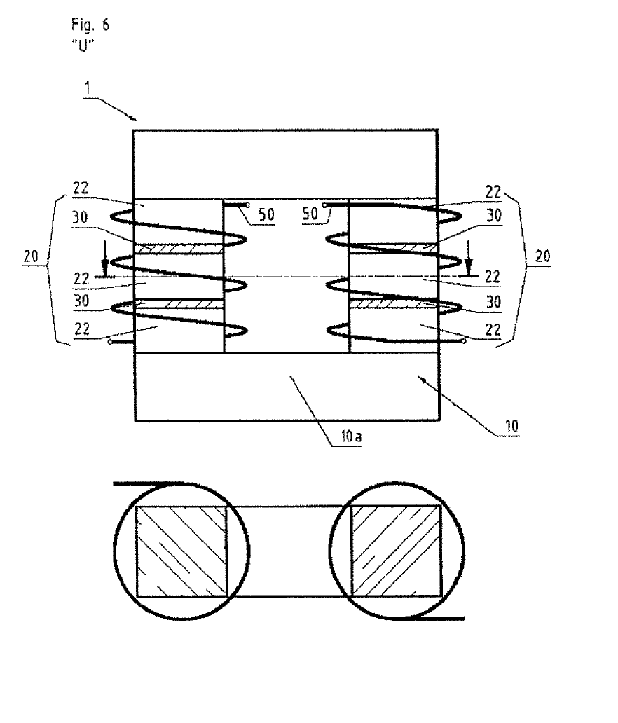

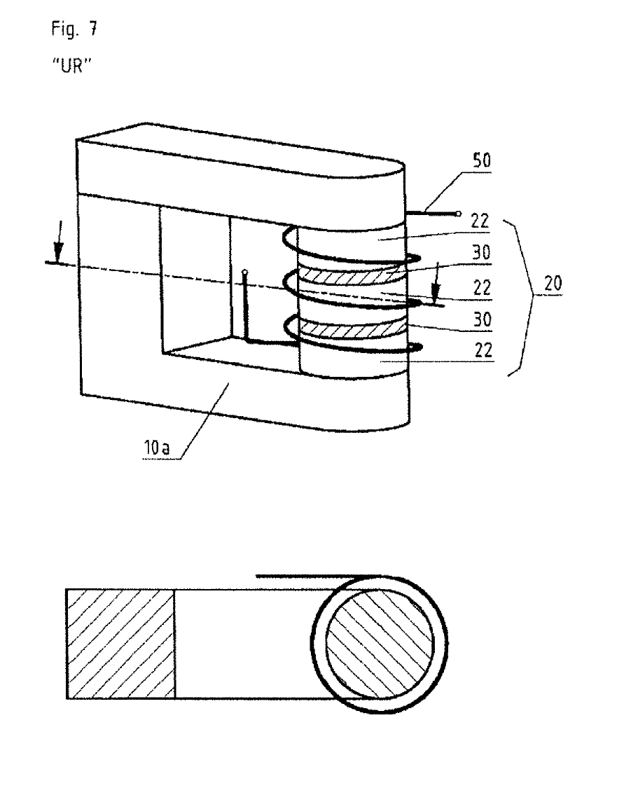

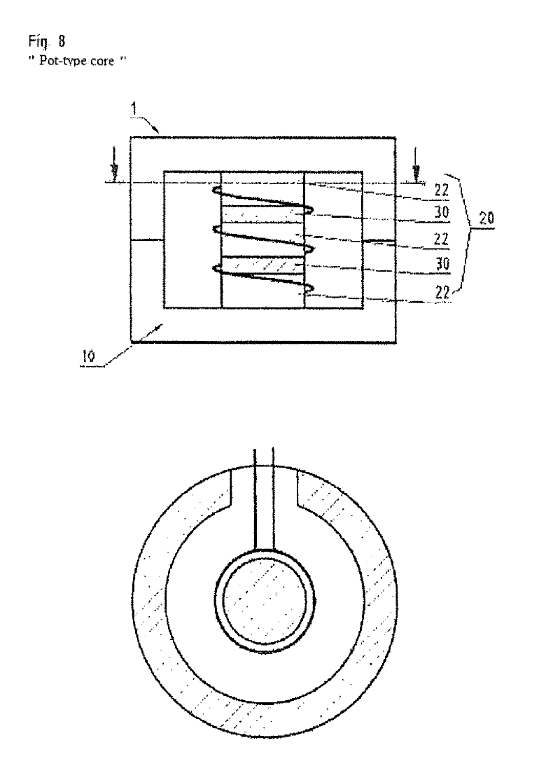

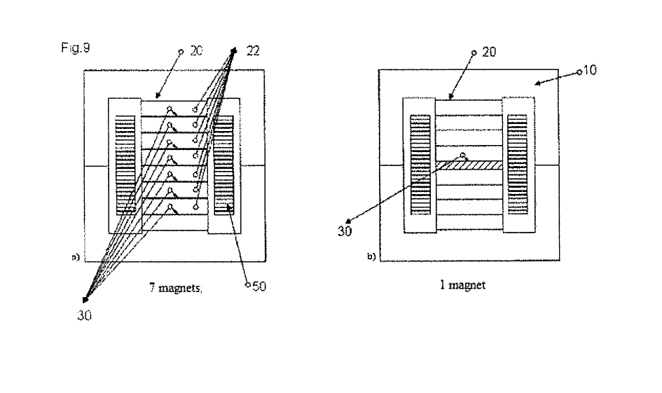

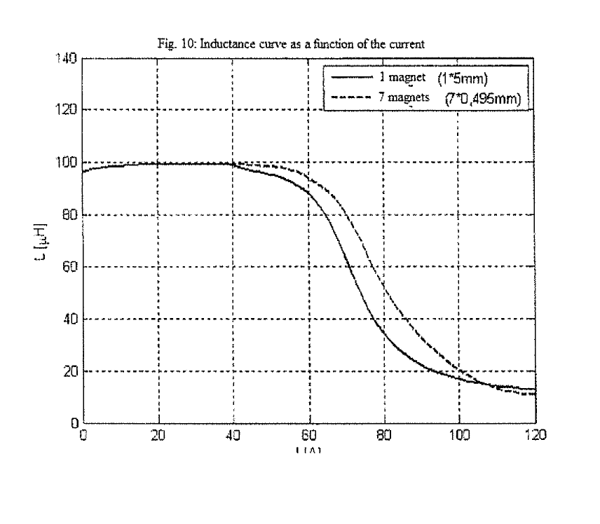

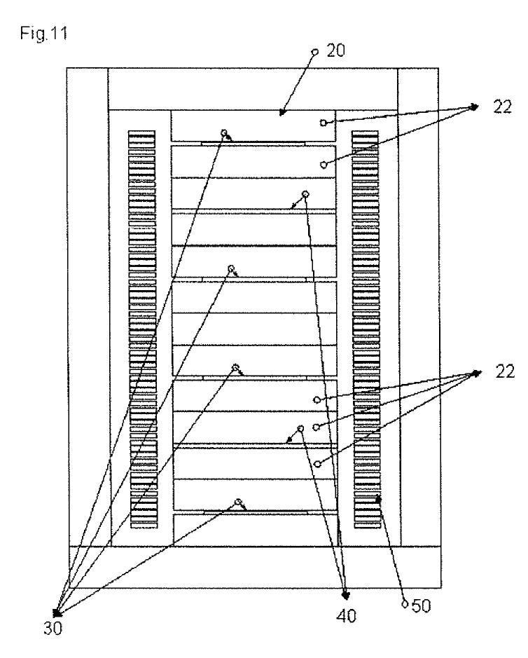

Such chokes or inductances are used as voltage regulators in the form of so-called buck converters or step-up converters, for example. One example for a so-called step-up converter is disclosed in the introductory part of the specification of DE 198 16 485 A1 and the FIG. 1 therein.

This DE 198 16 485 A1 furthermore shows to bias the inductance magnetically negative, by partially filling the only gap provided there with permanent magnetic material, wherein the permanent magnetic material in each case is arranged spaced apart from the magnetic circuit on the front. By inserting the permanent magnetic material into the gap, it is possible to shift the actual operating range of the inductance, because the possible magnetic lift, that is the possible maximum induction, is significantly increased by providing a permanent magnetic material in the gap.

EP 1 211 700 A1 moreover describes an inductive component with a so-called ETD-core, in which a permanent magnet segment is inserted into the center limb, or a permanent magnet segment is inserted into each of the outer limbs.

DE 24 24 131 A1 describes a similar inductive component, in which a segmented permanent magnet is inserted into the gap to minimize eddy current losses during the operation of this inductance.

According to this it is known to introduce normally one or multiple air gaps into the magnetic circuit of chokes to prevent saturation phenomena. This results in linearization of the component behavior, but also causes a number of problems at the same time. The cause is magnetic stray fields, which increasingly extend into the external space of the choke with increasing size of the air gap. To prevent this, the air gap or the gap filled with insulation material is disposed below the choke winding, in order to avoid electromagnetic interactions with electronic assemblies in the vicinity.

In addition, as previously mentioned, it is known with chokes to provide instead of an air gap or a gap filled with an insulator, a magnetic circuit with a multiplicity of air gaps, each of which are filled with insulators, in order to reduce the winding losses.

A further inductive device, in which a stack made up of multiple magnetically soft segments and permanent magnet segments is known, is described in WO 2012/016586 A1. There the stack has a stack direction that extends transversely between two yokes of the magnetic circuit. It is stated that the inductive device involves a ground current limiter.

The present invention is based on these findings.

Accordingly, there is a need for an improved magnetically biased choke that addresses at least one of the concerns noted above.

### ASPECTS AND SUMMARY OF THE INVENTION

According to one aspect of the invention there is provided a magnetically biased choke includes a magnetic circuit with at least one stack consisting of a plurality of magnetically soft segments), of which at least some are disposed at a spacing from each other, and of a coil which is wound about the stack, at least two permanent magnet segments being inserted into the stack and at least one magnetically soft segment being disposed between the at least two permanent magnet segments.

Another aspect of the present invention is to provide a choke, which, compared to previously known chokes, is improved in particular with respect to its current carrying capacity.

Such a choke has the following features:

a magnetic circuit with at least one stack consisting of a plurality of magnetically soft segments, of which at least some are disposed at a spacing from each other,

a coil, which is wound about the stack,

at least two permanent magnets being inserted into the stack,

at least one magnetically soft segment being disposed between the at least two permanent magnet segments, and

the stack has a stack direction, which is directed from one yoke to an opposite yoke of the magnetic circuit.

The present invention therefore essentially consists of providing a magnetically biased choke with at least two permanent magnet segments, between which a magnetically soft segment is disposed, the stack having a stack direction, which is directed from a first yoke to an opposite second yoke of the magnetic circuit and thus represents a series configuration of magnetically soft and magnetically hard stack elements.

A ferrite segment can be provided as a magnetically soft segment, for example. In addition, an amorphous nano-crystalline or even combined powder material can be used.

The conductivity can be increased with the choke according to the present invention, in that suitable permanent magnets are introduced into multiple gaps.

According to a refinement of the present invention, at least one insulator or an insulator segment is inserted into the stack consisting of a plurality of magnetically soft segments. The insulator can be air, for example, or an insulating component, i.e. an insulator segment. A plastic segment is also suitable as insulator segment, for example, such as a plastic disc.

It can also be provided that one permanent magnet segment is disposed between each of the magnetically soft magnets disposed at a spacing from each other. The advantage of having as many as possible permanent magnet segments is that based on a desired total remanence of the arrangement, it is possible to use cost-effective magnets.

However, is also quite easy to fill one gap or multiple gaps in the stack merely with one insulator or insulator segment and to insert permanent magnets only into some of the multiple gaps. Although, if the total remanence is specified, then magnets having a correspondingly higher remanence must be inserted, compared to stacks in which a plurality of permanent magnet segments is inserted.

According to the present invention, the material of the permanent magnet segments can be a magnetic material consisting of a combination of rare earths, in particular SmCo, NdFeB, SmFeN or a hard ferrite material, in particular SrFe, BaFe, or a mixture of these materials.

For reasons of installation and handling, there is also the option that the magnetically soft segments and the permanent magnet segments and, if needed, the insulation segments, have an identical outer contour and are stacked reciprocally aligned. In so doing, a circular or angular outer contour of the stack can be provided. A circular outer contour would produce a cylindrical stack, and with an angular outer contour, a stack having the shape of a square-section would result, for example.

The magnetic circuit of the choke according to the present invention can be designed as ETD-circuit, E-circuit, UR-circuit or as pot-type core and have a single stack about which a coil is wound.

It is also possible, however, that instead of so-called single-limb variants of magnetic circuits, also two-limb chokes are provided. For this purpose, so-called URR-circuits, U-circuits or UR-circuits with two adjacently disposed stacks each of which are wound from one coil are available, as they were previously described.

For the assembly of a choke according to the present invention, it is especially advantageous if the stack of magnetically soft segments and permanent magnet segments and an optionally provided insulator segment or insulator segments, is provided as a pre-assembled portable unit.

The individual components of such pre-assembled portable unit are connected fixed together, preferably bonded, potted, or covered with a suitable material.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a first embodiment of a choke according to the present invention with a magnetic circuit in ETD-form, into which a stack consisting of a plurality of magnetically soft segments and permanent magnets has been inserted, as a lateral view and cross-section shown together.

FIG. 2 is the stack inserted in FIG. 1, as a pre-assembled portable unit, as a lateral view.

FIG. 3 is the stack of FIGS. 1 and 2 in plan view with a circular outer contour.

FIG. 4 is a second embodiment of a choke according to the present invention in URR-configuration with two inserted stacks consisting of magnetically soft segments and permanent magnetic segments, as a lateral view and cross-section.

FIG. 5 is a third embodiment of a choke according to the present invention with a magnetic circuit in E-form, as a lateral view and cross-section.

FIG. 6 is a fourth embodiment of a choke according to the present invention with a magnetic circuit in U-configuration, as a lateral view and cross-section.

FIG. 7 is a fifth embodiment of a choke according to the present invention with a magnetic circuit in UR-form, with a single stack provided there.

FIG. 8 is a sixth embodiment of a choke according to the present invention with a pot-type core, as a lateral view and cross-section.

FIG. 9 is a similar configuration of chokes, as they were represented in FIG. 1, however with always one stack with seven magnetically soft segments arranged on top of each other, between which the seven permanent magnets are inserted in one case, and in one case only a single, but thicker permanent magnet segment, is inserted.

FIG. 10 is a result of a simulation of the inductance curve of the chokes illustrated in FIG. 9, as function of the current.

FIG. 11 is a further embodiment of a choke similar to the representation of FIG. 1, but with permanent magnet segments that are narrower than the magnetically soft segments.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Unless stated otherwise, in the following figures same reference numbers indicate same components with the same meaning.

FIG. 1 shows a first embodiment of a choke according to the present invention, as a lateral view and cross-section. The choke is marked with the reference symbol 1 and has a magnetic circuit 10, which is formed as ETD-circuit. For this purpose, the magnetic circuit 10 has a lower yoke 10a, which runs horizontal and on the left and right end of which the yokes 10b and 10c connect which extend vertically to the top. These two yokes 10b, 10c are connected at their top end by means of a further yoke 10d that runs transversely. These yokes 10a, 10b, 10c and 10d involve a magnetically soft material. A stack 20 consisting of a plurality of magnetically soft segments 22 is placed centric in such a way that the stack 20 is connected on its upper and lower end with the lower yoke 10a and the upper yoke 10d. But here, also an air gap, a permanent magnet segment or an insulator segment can be placed.

The magnetic circuit 10 with its yokes 10a, 10b, 10c and 10d as well as the centric stack 20 has the form which is typical for an ETD-structure. A coil 50 is wound about the stack 20.

The stack 20 is once more illustrated separately, in FIG. 2 as a lateral view and in FIG. 3 in plan view. In the embodiment, this stack 20 consists of six magnetically soft segments 22 arranged on top of each other, each of which are disposed at a spacing from each other. In each case, an air gap or insulator segment 40 is disposed between the three top magnetically soft segments 22. This insulator segment 40 can be a plastic segment or similar, for example. Viewed from the top, in each case a permanent magnetic segment 30 is placed between the third and fourth as well as the fourth and fifth as well as the fifth and sixth magnetically soft segment 22.

The entire configuration of the stack 20, illustrated in FIG. 2, is oriented reciprocally aligned and, as shown in FIG. 3, has a circular outer contour. In this case, it is also conceivable, however, to provide an angular contour. The individual components of the stack 20, i.e. the magnetically soft segments 22, the insulator segments 40 as well as the permanent magnet segments 30, are installed fixed together, i.e. in particular bonded together. But it is also easily possible that a suitable material is potted or wound about the entire stack 20. A suitable material for such potting or winding is a resin material, for example polyamide, polyurethane, polypropylene, epoxy, or also silicone. Such potting or winding can be provided in tubular form, for example, such as is indicated by a dash-dot line and the reference symbol 60 in FIG. 2. Such sleeve-like winding 60 has the advantage that the upper side of the top magnetically soft segment 22 and the underside of the lowest magnetically soft segment remains free, to be able to attach directly onto the yokes 10a and 10d mentioned in connection with FIG. 1. In FIGS. 2 and 3, the winding 60 with the reference symbol 60 is designed tubular.

The material for the magnetically soft segments 22 can be ferrite, amorphous material, nano-crystalline material or combined powder material, for example, or be present in the form of iron sheets.

The material of the permanent magnet segments 30 can be a magnetic material made up of a combination of rare earths, in particular SmCo, NdFeB, SmFeN or a hard ferrite material, in particular SrFe, BaFe, or a mixture of these materials.

Even though it was mentioned in connection with FIGS. 1 and 2 that merely three permanent magnetic segments 30 are provided, each of the gaps provided between the magnetically soft segments 22 can be easily filled with a permanent magnetic segment 30.

Although previously, only a magnetic circuit 10 in ETD-form was discussed, it is easily possible to use other forms of magnetic circuits 10, as shown in FIGS. 4, 5, 6 and 7.

FIG. 4 thus shows a magnetic circuit 10 in URR-form. The magnetic circuit 10 has merely two yokes 10a and 10d, which are disposed reciprocally parallel and between these two yokes 10a and 10d two stacks 20 positioned reciprocally parallel with magnetically soft segments 22 and permanent magnetic segments 30 in-between and in this embodiment, one single insulator segment 40 positioned in-between. In each case, a coil 50 is wound about these two stacks 20, as already explained in the previous embodiment of FIG. 1. Also these coils 50 are wound about the stack 20 such that the coil 50 is wound about the permanent magnet segments 30 and also the air gap 40.

FIG. 5 shows a third embodiment with a magnetic circuit 10 in E-form. The magnetic circuit 10 consists of a yoke 10a that extends transverse at the bottom, from which two yokes 10b, 10c extend towards the top. The already familiar stack 20 is disposed between these two limbs 10b, 10c.

FIG. 6 shows a magnetic circuit 10 in U-form. Here, merely a yoke 10a of the magnetic circuit 10 that extends transversely is provided, on the ends of which circuit the already familiar stacks 20 rest, about each of which a coil 50 is wound.

The embodiment of FIG. 7 shows a magnetic circuit 10 in UR-form with a yoke 10a that is positioned transversely and has a rectangular cross-sectional contour. A yoke 10b, which also has a rectangular cross-section, extends from this yoke 10a in one piece to the top. On the right end of this yoke 10a rests the already familiar stack 20 with its magnetically soft segments 22 and with the permanent magnet segment 30 and an air gap 40.

The embodiment of FIG. 8 shows a choke with a pot-type core, which has a circular yoke 10 with an upper and lower cover and a centrically disposed stack 20 with permanent magnetic segments 30 and magnetically soft segments 22.

The illustrations in FIG. 9 and FIG. 10 clarify what influence the number of permanent magnetic segments 30 has on the inductance curve of the choke.

FIG. 9 illustrates two almost identically structured magnetic circuits 10, similar to FIG. 1, wherein the stack 20 located in the center varies with respect to its number of permanent magnetic segments 30 used. The previously known reference symbols are used for the same parts. For reasons of clarity, merely arrows have been entered in the configurations of the magnetic circuits 10 of FIG. 8 at the locations where permanent magnet segments 30 are inserted between the magnetically soft segments 22. On two opposite magnetically soft segments 22, where no arrow is drawn, two magnetically soft segments 22 are positioned directly on top of each other.

As the illustration in FIG. 9 shows on the left, the stack 20 has a total of eight magnetically soft segments 22. In each case, one permanent magnetic segment 30 lies between all magnetically soft segments 22. One coil 50 is wound about the entire stack 20. In the illustration of FIG. 9 on the right, the stack 20 is also equipped with eight magnetically soft segments 22. However, only a single permanent magnetic segment 30 lies between the fourth and fifth magnetically soft segment 22, which permanent magnetic segment is significantly thicker than the total of the seven permanent magnet segments 30 of FIG. 9 on the left. Again, one coil 50 is wound about the entire stack 20.

If it is implied that the two chokes shown in FIG. 9 should have the same initial inductance, then the following is to be considered. If there is merely one permanent magnetic segment 30 between two magnetically soft segments 22, then the magnetic fields which are conducted in the magnetic circuit 1, project into the coil 50. In this context, the greater the spacing between two magnetically soft segments 22, i.e., the thicker the permanent magnetic segment 30 that is inserted there is, the more these fields project into the coil 50. This results in additional losses with high-frequency currents. If the spacing of the reciprocally opposite magnetically soft segments 22 is narrower however, i.e. a thinner permanent magnetic segment 30 is inserted between the two magnetically soft segments 22, then these fields no longer project as far, so that the losses are comparatively less.

Such projecting fields are the cause why a large gap between two magnetically soft segments 22 effectively has a larger cross-section. As a result, the magnetic resistance of the gap decreases, which in turn is balanced by making the gap wider.

Assuming that the choke illustrated in FIG. 9 on the right has a single gap, into which a permanent magnetic segment 30 with a thickness of 5.0 mm is inserted and that a magnetically soft segment 22 is immediately adjacent on the top and on the bottom of this permanent magnetic segment 30, then this corresponds to a choke with seven gaps as is shown in FIG. 9 on the left, into each of which a permanent magnet segment 30 is inserted, wherein said gaps must merely have a thickness of 0.495 mm. If these seven thicknesses of the permanent magnetic segments 30 are added, then merely a total gap or a total thickness of 3.465 mm results for the individual permanent magnetic segments 30, however. But because of the losses that were discussed earlier, these will correspond to an effective thickness of 5.0 mm to obtain the same initial inductance.

In this case, the actual conversion is done using the known method of conformal imaging from the theory of functions.

Based on this finding, it is obvious that by using a multiplicity of thin permanent magnet segments 30 compared to one thick permanent magnet segment 30, it is possible to attain an identical initial inductance and the magnetic volume is still reduced, nevertheless.

An additional advantage results moreover, which becomes clear with the aid of FIG. 10. In FIG. 10, the inductance curve of the two chokes illustrated in FIG. 9 is plotted as function of the current at the same initial inductance of almost 100 μH. The solid line corresponds to the choke illustrated on the right in FIG. 9 with a thick permanent magnet segment 30, while the dashed line corresponds to the choke on the left in FIG. 9. Assuming that the chokes shown in FIG. 9 have one stack 20 with an identical outside diameter, then FIG. 10 clearly shows that the inductance curve is shifted to the right if more than one permanent magnet segment 30 is used. Therefore, at the same initial conductance, more current can be conducted in the choke with the seven permanent magnet segments 30 than in the variant which has only one permanent magnet segment 30.

Overall, when using multiple permanent magnet segments 30 in the stack 20, miscellaneous advantages result compared to using only a single permanent magnet segment 30, that is to say that less magnetic material must be used, in that because of the smaller gaps, less copper will be lost in the coil 50, a higher saturation of such type of choke can be attained, and finally that a lower proximity effect occurs.

FIG. 11 illustrates a further embodiment of a choke according to the present invention. This embodiment corresponds largely to the illustration of a choke of FIG. 1. However, now a total of thirteen magnetically soft segments 22 are provided in the stack 20, for example, wherein the permanent magnet segments 30 inserted between these magnetically soft segments 22 are formed significantly narrower than the other components of the stack 20. This means that the magnetically soft segments 22 on the left and on the right in the cross-sectional view of FIG. 11, project beyond the permanent magnet segments 30.

In an actual case, when viewed from the top of the stack 20, a narrower permanent magnet segment 30 is inserted between each of the following: between the first and second magnetically soft segment 22, between the eighth and ninth magnetically soft segment 22, and between the twelfth and thirteenth magnetically soft segment 22. These permanent magnet segments 30 are also formed distinctly thinner than the magnetically soft segments 22. In the embodiment illustrated in FIG. 11 it is additionally provided that an insulation segment 40 is inserted between the third and fourth magnetically soft segment 22 and between the tenth and eleventh magnetically soft segment 22. These insulation segments 40 have the same outer contour as the outer contour of the magnetically soft segments 22, but can also be formed narrower or wider than these, if needed.

### LIST OF REFERENCE SYMBOLS

1 choke
10 magnetic circuit 10a, b, c, d yoke
20 stack
22 magnetically soft segment, in particular ferrite segment
22a first main surface of a ferrite segment
22b second main surface of a ferrite segment
30 permanent magnet segment
40 insulator segment, insulator
50 coil
60 winding
A outer contour
E portable unit

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1. A magnetically biased choke comprising:
a magnetic circuit with at least one stack consisting of a plurality of magnetically soft segments, of which at least one is disposed at a spacing from respective other said magnetically soft segments;
a coil which is wound about the stack;
said coil further comprising:
at least two permanent magnet segments inserted into the stack;
at least one magnetically soft segment being disposed between the at least two permanent magnet segments;
said stack comprises a stack direction, which is directed from one yoke to another opposite yoke of the magnetic circuit; and
a coil having a coil axis that is arranged in parallel to the stack direction.

2. The magnetically biased choke according to claim 1, further comprising:
at least one of an insulator and an insulator segment is disposed in the stack consisting of multiple magnetically soft segments.

3. The magnetically biased choke according to claim 1, wherein:
one permanent magnet segment is disposed between each of all said magnetically soft segments that are disposed at a spacing from each other.

4. The magnetically biased choke according to claim 1, wherein:
a material of the permanent magnet segments is a magnetic material consisting of a combination of rare earths, selected from a group of rare earths consisting of: SmCo, NdFeB, SmFeN and a hard ferrite material, in particular SrFe, BaFe, or a mixture of these materials.

5. The magnetically biased choke according to claim 1, wherein:
the magnetically soft segments and permanent magnet segments further comprise an identical outer contour and are stacked reciprocally aligned.

6. The magnetically biased choke according to claim 5, wherein:
the magnetically soft segments and permanent magnet segments further comprise a circular or angular outer contour (A).

7. The magnetically biased choke according to claim 1: wherein:
the magnetic circuit is formed as one of an ETD-circuit, a UR-circuit or pot-type core and further comprises one single stack about which a coil is wound.

8. The magnetically biased choke according to claim 1, wherein:
the magnetic circuit is formed as one of an URR-circuit, a U-circuit and a UR-circuit with two adjacently disposed stacks about each of which one coil is wound.

9. The magnetically biased choke according to claim 1 wherein:
the stack further comprises magnetically soft segments and permanent magnet segments and at least one insulator segment is provided as a pre-assembled portable unit (E).

10. The magnetically biased choke according to claim 9, wherein:
the individual components of the stack are connected fixed together, preferably bonded, potted, or covered.

11. The magnetically biased choke according to claim 1, wherein:
the magnetically soft segment is a ferrite segment.

12. The magnetically biased choke according to claim 1, wherein:
the magnetically soft segment is a material selected from a group of materials consisting of an amorphous material, a nano-crystalline material and a combined powder material.

13. The magnetically biased choke according to claim 1, wherein:
the magnetically soft segments are projecting above the side of the permanent magnetic segments.

14. A magnetically biased choke, comprising:
a magnetic circuit with at least one stack consisting of a plurality of magnetically soft segments, of which at least one is disposed at a spacing from respective other said magnetically soft segments;
a coil which is wound about the stack;
said coil further comprising:
at least two permanent magnet segments inserted into the stack;
at least one magnetically soft segment being disposed between the at least two permanent magnet segments;
said stack comprises a stack direction, which is directed from one yoke to another opposite yoke of the magnetic circuit; and
a coil having a coil axis that is arranged in parallel to the stack direction;
at least one of an insulator and an insulator segment is disposed in the stack consisting of multiple magnetically soft segments; and
one permanent magnet segment is disposed between each of all said magnetically soft segments that are disposed at a spacing from each other.

15. The magnetically biased choke, according to claim 14, wherein:
the magnetically soft segments and permanent magnet segments further comprise an identical outer contour and are stacked reciprocally aligned.

16. The magnetically biased choke, according to claim 15, wherein:
the magnetically soft segments and permanent magnet segments further comprise a circular or angular outer contour (A).

17. The magnetically biased choke, according to claim 16: wherein:
the magnetic circuit is formed as one of an ETD-circuit, a UR-circuit or pot-type core and further comprises one single stack about which a coil is wound.

18. The magnetically biased choke, according to claim 1, wherein:
the magnetic circuit is formed as one of an URR-circuit, a U-circuit and a UR-circuit with two adjacently disposed stacks about each of which one coil is wound.

19. A magnetically biased choke, comprising:
a magnetic circuit with at least one stack consisting of a plurality of magnetically soft segments, of which at least one is disposed at a spacing from respective other said magnetically soft segments;
a coil which is wound about the stack;
said coil further comprising:
at least two permanent magnet segments inserted into the stack;
at least one magnetically soft segment being disposed between the at least two permanent magnet segments;
said stack comprises a stack direction, which is directed from one yoke to another opposite yoke of the magnetic circuit; and
a coil having a coil axis that is arranged in parallel to the stack direction;
at least one of an insulator and an insulator segment is disposed in the stack consisting of multiple magnetically soft segments;
one permanent magnet segment is disposed between each of all said magnetically soft segments that are disposed at a spacing from each other; and
wherein a material of the permanent magnet segment is a magnetic material consisting of a combination of rare earths, selected from a group of rare earths consisting of: —SmCo, NdFeB, SmFeN and a hard ferrite material, in particular SrFe, BaFe, or a mixture of these materials.

20. The magnetically biased choke, according to claim 19, wherein:
the magnetically soft segment is a material selected from a group of materials consisting of an amorphous material, a nano-crystalline material and a combined powder material.
